(19) United States
(12) Patent Application Publication
(10) Pub. No.: US 2013/0144485 A1
(43) Pub. Date: Jun. 6, 2013

(54) AUTOMATIC TRANSMISSION FOR SHIFT BY WIRE

(71) Applicants: Jeehyuck Choi, Hwaseong-si (KR); Yangrae Cho, Hwaseong-si (KR); Kwanggi Lee, Daegu (KR); Dongjae Kim, Gyeongsan-si (KR)

(72) Inventors: Jeehyuck Choi, Hwaseong-si (KR); Yangrae Cho, Hwaseong-si (KR); Kwanggi Lee, Daegu (KR); Dongjae Kim, Gyeongsan-si (KR)

(73) Assignees: Hyundai Motor Company, Seoul (KR); SL Corporation, Daegu (KR); Kia Motors Corporation, Seoul (KR)

(21) Appl. No.: 13/488,852

(22) Filed: Jun. 5, 2012

(30) Foreign Application Priority Data
Dec. 6, 2011 (KR) 10-2011-0129529

(51) Int. Cl. G06F 7/00

(52) U.S. Cl. 701/36; 701/56

(57) ABSTRACT

An automatic transmission for shift-by-wire that includes a transmission that is selectively operated by a plurality of traveling-drive modes relating to shifting, a shift lever that includes a tiltable handle and a tilt sensor that senses tilting of the handle, and a control unit that calculates tilting information on the basis of a tilting signal sensed by the tilt sensor, selects one of the traveling-drive modes by using the calculated tilting information, and sets the transmission to be operated in the selected traveling-drive mode. As described above, it is possible for a driver to easily perform an operation for changing drive modes while driving, by changing the drive modes by using a tilting operation of a shift lever, such that the drive safety can be improved.

### CROSS-REFERENCE TO RELATED APPLICATIONS

The present application claims priority of Korean Patent Application Number 10-2011-129529 filed Dec. 6, 2011, the entire contents of which application is incorporated herein for all purposes by this reference.

### BACKGROUND OF INVENTION

1. Field of Invention

The present invention relates to an automatic transmission for shift-by-wire (SBW), and particularly, to an automatic transmission for shift-by-wire that allows a driver to select a safety mode.

2. Description of Related Art

An automatic transmission for shift-by-wire electronically performs shifting control by using an electronic shift lever and an ECU. Recently, a transmission for shift-by-wire is provided with a drive mode selector making it possible to select drive modes (NORMAL, SPORT, and ECO) relating to shifting, for the convenience of the driver.

Drive mode selectors of the related art are user input units for selecting drive modes (NORMAL, SPORT, and ECO) relating to shifting, and a rotary type of switch and a button type of switch are generally used.

However, since the drive mode selector is disposed on the dashboard of a vehicle, separate from the shift lever, in the related art, it is troublesome to operate the selector while driving, such that the safety of driving may be reduced Further, the switch type has a problem in that it is difficult to implement the switch type such that various drive modes are selected.

As described above, it is possible for a driver to easily perform an operation for changing drive modes while driving, by changing the traveling-drive modes by using a tilting operation of a shift lever, such that the drive safety can be improved.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an automatic transmission for shift-by-wire that can improve the drive safety by allowing a driver to easily perform an operation of changing traveling-drive modes while driving.

Various aspects of the present invention provide for an automatic transmission for shift-by-wire, including: a transmission that is selectively operated by a plurality of traveling-drive mode relating to shifting, a shift lever that includes a tiltable handle and a tilt sensor that senses tilting of the handle, and a control unit that calculates tilting information on the basis of a tilting signal sensed by the tilt sensor, selects one of the traveling-drive mode by using the calculated tilting information, and sets the transmission to be operated in the selected traveling-drive mode.

When the calculated tilting information includes the forward tilting number of times when the handle is tilted forward with respect to the horizontal position and the backward tilting number of times when it is tilted backward, the control unit may select the traveling-drive mode step by step by using the forward tilting number of times and the backward tilting number of time.

When the traveling-drive mode includes step modes of a SPORT mode, a NORMAL mode, and an ECO mode, from a high step to a low step, the control unit may select the NORMAL mode of the traveling-drive mode when there are no forward tilting number of times and backward tilting number of times, may select one of the step modes moved toward the high step, which is the SPORT mode, in proportionate to the forward tilting number of times when there is the forward tilting number of times, and may select one of the step modes moved toward the low step, which is the ECO mode, in proportionate to the backward tilting number of times when there is the backward tilting number of times.

When the calculated tilting information includes a forward tilting maintenance time where the handle is tilted forward with respect to the horizontal position and a backward tilting maintenance time when it is tilted backward, the control unit may select the traveling-drive mode step by step by using the forward tilting maintenance time and the backward tilting maintenance time.

When the traveling-drive mode includes step modes of a SPORT mode, a NORMAL mode, and an ECO mode, from a high step to a low step, the control unit may select the NORMAL mode of the traveling-drive mode when there are no forward tilting maintenance time and backward tilting maintenance time, may select one of the step modes moved toward the high step, which is the SPORT mode, in proportionate to the forward tilting maintenance time when there is a forward tilting maintenance time, and may select one of the step modes moved toward the low step, which is the ECO mode, in proportionate to the backward tilting maintenance time when there is a backward tilting maintenance time.

The automatic transmission may further include a display unit that displays a signal corresponding to the selected traveling-drive mode to the outside, in which the control unit may control the display unit such that a signal corresponding to the selected traveling-drive mode is displayed to a drive.

As described above, it is possible for a driver to easily perform an operation for changing drive modes while driving, by changing the traveling-drive modes by using a tilting operation of a shift lever, such that the drive safety can be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary automatic transmission for shift-by-wire according to the present invention.

FIG. 2 is a diagram of changes in a traveling-drive mode according to the tilting number of times of an exemplary automatic transmission for shift-by-wire according to the present invention.

FIG. 3 is a diagram of changes in a traveling-drive mode according to the tilting maintenance time of an exemplary automatic transmission for shift-by-wire according to the present invention.

FIG. 4 is a flow chart for explaining the operation of various embodiments of the present invention relating to FIG. 3.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

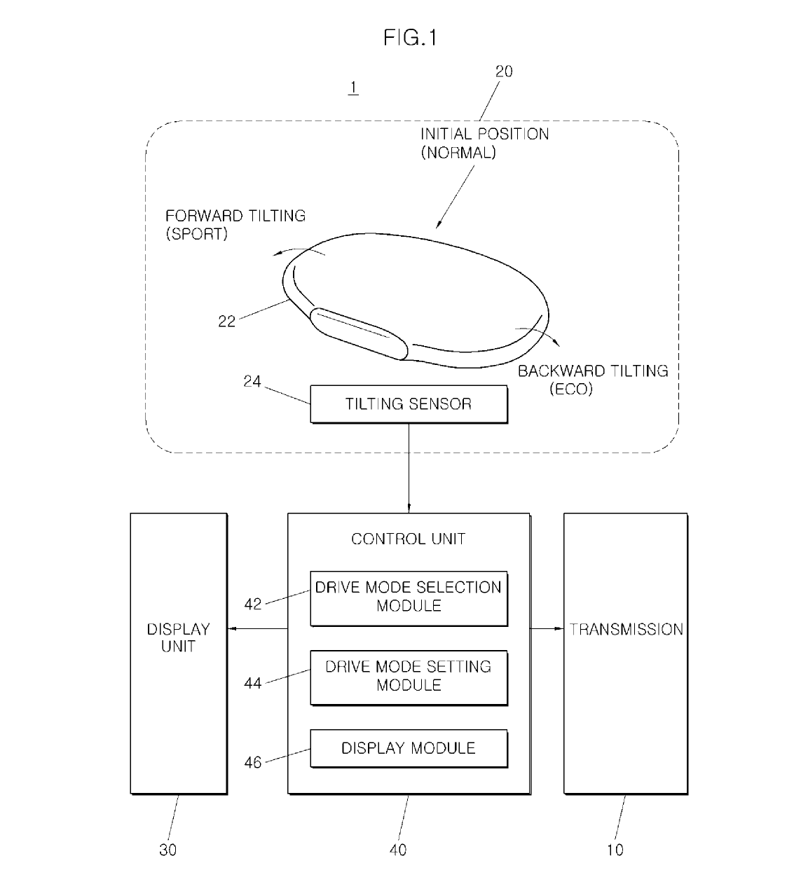

FIG. 1 is a block diagram of an automatic transmission for shift-by-wire according to various embodiments of the present invention. Referring to FIG. 1, an automatic transmission 1 for shift-by-wire may includes a transmission 10, a shift lever 20, a display unit 30, and a control unit 40.

Transmission 10 is for shift-by-wire (SBW) and may be shifted for traveling and parking in accordance with the operation of shift lever 20. Further, transmission 10 may be selectively operated by a plurality of traveling-drive mode relating to shifting.

Shift lever 20 is composed of a tiltable handle 22 and a tilt sensor 24. Hand 22 can be tilted forward or backward with respect to a horizontal position.

Tilt sensor 24 can separately sense whether handle 22 is tilted forward or backward and can generate and transmit a tilting signal, which has a length corresponding to the tilting maintenance time of handle 22, to control unit 40.

Display unit 30 is a device for displaying a signal, which corresponds to a selected traveling-drive mode, to the outside, generally positioned such that the drive may easily check the display unit, and may be implemented by an LED module or an LCD panel.

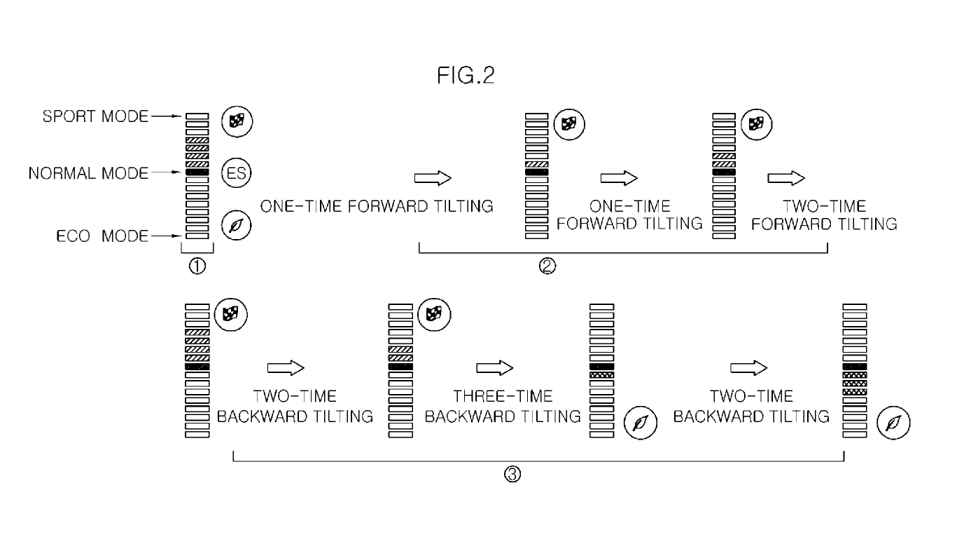

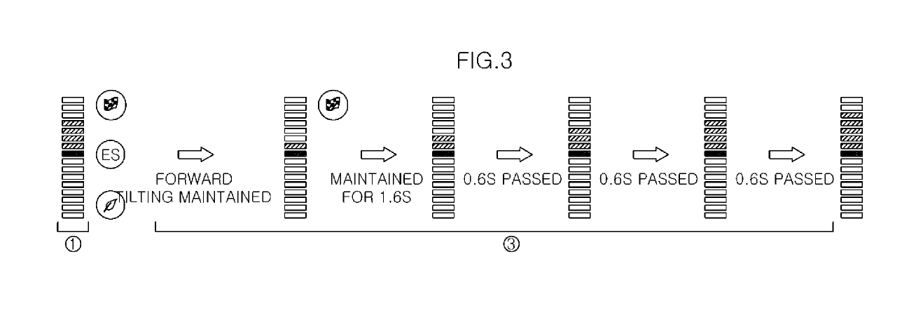

For example, as shown in FIG. 2 or 3, when the traveling-drive mode is composed of a plurality of step modes, display unit 30 may be implemented by an LED module with a plurality of LEDs arranged in a line downward from above to display the step modes.

Control unit 40, as shown in FIG. 1, may be divided into a drive selection module 42, a drive mode setting module 44, and a display module 46. The functional division is for the convenience of description and control unit 40 according to various embodiments is not limited to the division.

Drive mode selection module 42 calculates tilting information on the basis of a tilting signal sensed by tilt sensor 24 and can select one of the traveling-drive modes by using the calculated tilting information.

Drive mode setting module 44 sets transmission 10 for operation in the selected traveling-drive mode and display module 46 controls display unit 30 such that a signal corresponding to the selected traveling-drive mode is displayed to the drive.

When the calculated tilting information includes the forward tilting number of times or count when handle 22 is tilted forward with respect to the horizontal position and the backward tilting number of times or count when it is tilted backward, control unit 40 can select the traveling-drive mode step by step by using the forward tilting number of times and the backward tilting number of times.

As shown in FIG. 2, when the traveling-drive mode includes step modes of a SPORT mode, a NORMAL mode, and an ECO mode, from a high step to a low step, control unit 40 selects the NORMAL mode of the traveling-drive mode indicated by ‘\textcircled{1}’ in FIG. 2 when there are no forward tilting number of times and backward tilting number of times, selects one of the step modes moved toward the high step, which is the SPORT mode, in proportionate to the forward tilting number of times indicated by ‘\textcircled{2}’ of FIG. 2 when there is the forward tilting number of times, and selects one of the step modes moved toward the low step, which is the ECO mode, in proportionate to the backward tilting number of times indicated by ‘\textcircled{3}’ of FIG. 2 when there is the backward tilting number of times.

When the calculated tilting information includes a forward tilting maintenance time where handle 22 is tilted forward with respect to the horizontal position and a backward tilting maintenance time when it is tilted backward, control unit 40 can select the traveling-drive mode step by step by using the forward tilting maintenance time and the backward tilting maintenance time.

As shown in FIG. 3, when the traveling-drive mode includes step modes of a SPORT mode, a NORMAL mode, and an ECO mode, from a high step to a low step, control unit 40 may select the NORMAL mode of the traveling-drive mode indicated by ‘\textcircled{1}’ of FIG. 3 when there are no forward tilting maintenance time and backward tilting maintenance time, and may select one of the step modes moved toward the high step, which is the SPORT mode, in proportionate to the forward tilting maintenance time indicated by ‘\textcircled{2}’ of FIG. 3 when there is a forward tilting maintenance time.

Though not shown in FIG. 3, when there is a backward tilting maintenance time, one of the step modes moved toward the low step, which is the ECO mode, in proportionate to the backward tilting maintenance time can be selected.

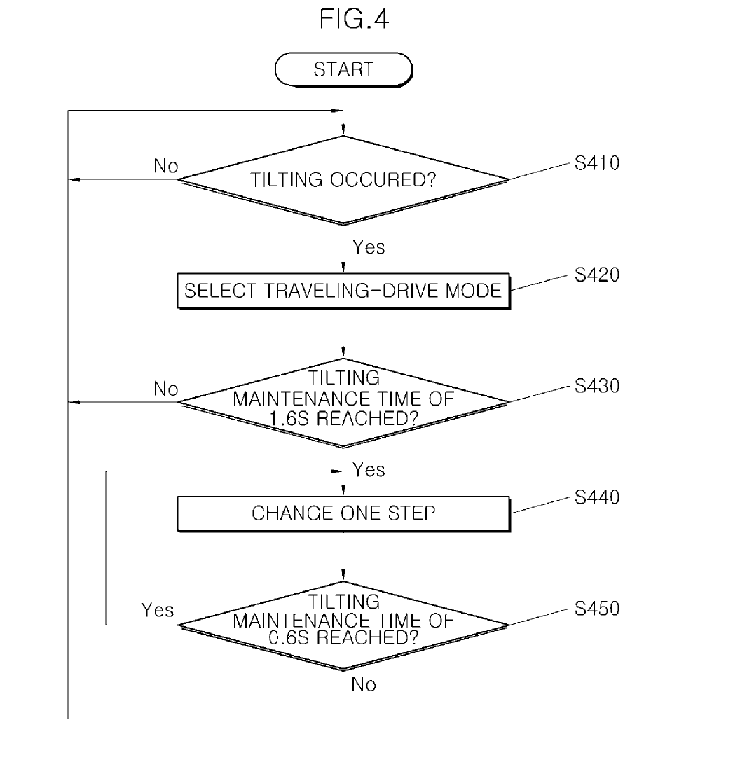

Hereafter, the operation according to various embodiments of the present invention, relating to FIG. 3 is described with reference to FIG. 4.

First, control unit 40 determines whether tilting of handle 22 is generated (S410) and enters a step of selecting a traveling-drive mode when tilting is generated (S420). Next, control unit 40 determines whether the tilting maintenance time of handle 22 is not less than 1.6 seconds (S430) and moves the step modes toward the high step indicated by ‘\textcircled{2}’ of FIG. 3 when it is not less than 1.6 seconds (S440). The movement of the step modes is repeated every tilting maintenance time of 0.6 seconds (S450).

As described above, automatic transmission 1 for shift-by-wire according to various embodiments of the present invention allows the driver to easily perform an operation for changing the drive mode in driving, by changing the traveling-drive mode by using a tilting operation of shift lever 20, such that it is possible to improve the drive safety.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An automatic transmission for shift-by-wire comprising:
a transmission selectively operated by a plurality of traveling-drive modes relating to shifting;
a shift lever that includes a tiltable handle and a tilt sensor that senses tilting of the handle; and
a control unit that calculates tilting information on the basis of a tilting signal by the tilt sensor, selects one of the traveling-drive modes by using the calculated tilting information, and sets the transmission to be operated in the selected traveling-drive mode.

2. The automatic transmission as defined in claim 1, wherein when the calculated tilting information includes a forward tilting count of when the handle is tilted forward with respect to the horizontal position and a backward tilting count of when the handle is tilted backward, the control unit selects the traveling-drive mode step by step by using the forward tilting count and the backward tilting count.

3. The automatic transmission as defined in claim 2, wherein when the traveling-drive mode includes step modes of a SPORT mode, a NORMAL mode, and an ECO mode, from a high step to a low step, the control unit selects the NORMAL mode of the traveling-drive mode when there is no forward tilting count and no backward tilting count, selects one of the step modes moved toward the high step, which is the SPORT mode, in proportionate to the forward tilting count when there is the forward tilting count, and selects one of the step modes moved toward the low step, which is the ECO mode, in proportionate to the backward tilting count when there is the backward tilting count.

4. The automatic transmission as defined in claim 1, wherein when the calculated tilting information includes a forward tilting maintenance time where the handle is tilted forward with respect to the horizontal position and a backward tilting maintenance time when the handle is tilted backward, the control unit selects the traveling-drive mode step by step by using the forward tilting maintenance time and the backward tilting maintenance time.

5. The automatic transmission as defined in claim 4, wherein when the traveling-drive mode includes step modes of a SPORT mode, a NORMAL mode, and an ECO mode, from a high step to a low step, the control unit selects the NORMAL mode of the traveling-drive mode when there are no the forward tilting maintenance time and the backward tilting maintenance time, selects one of the step modes moved toward the high step, which is the SPORT mode, in proportionate to the forward tilting maintenance time when there is the forward tilting maintenance time, and selects one of the step modes moved toward the low step, which is the ECO mode, in proportionate to the backward tilting maintenance time when there is the backward tilting maintenance time.

6. The automatic transmission as defined in claim 1, further comprising:
a display unit that displays a signal corresponding to the selected traveling-drive mode to the outside;
wherein the control unit controls the display unit such that a signal corresponding to the selected traveling-drive mode is displayed.
